(19) United States
(12) Patent Application Publication
(10) Pub. No.: US 2026/0247356 A1
(43) Pub. Date: Aug. 20, 2026

(54) TIMING CONTROL OF RELAY STATION CONTROLLED BY NETWORK

(71) Applicant: RAKUTEN MOBILE, INC., Tokyo (JP)

(72) Inventors: Koichiro KITAGAWA, Tokyo (JP); Awn MUHAMMAD, Tokyo (JP)

(73) Assignee: RAKUTEN MOBILE, INC., Tokyo (JP)

(21) Appl. No.: 18/566,276

(22) PCT Filed: Nov. 25, 2022
(86) PCT No.: PCT/JP2022/043548

§ 371 Date: May 7, 2026

(30) Foreign Application Priority Data
Sep. 28, 2022 (JP) 2022-155234

(51) Int. Cl. H04W 72/0446; H04L 5/14; H04W 72/20; H04W 88/12

(52) U.S. Cl. CPC H04W 72/0446; H04L 5/1469; H04W 72/20; H04W 88/12

(57) ABSTRACT

A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein the communication control apparatus includes at least one processor that performs, by a timing controller, controlling an uplink transmission timing of the relay station to the radio access network in the relay of the uplink communication to be after the timing at which an uplink processing delay of the relay station in the relay is added to an uplink reception timing of the relay station from the communication device in the relay.

### TECHNICAL FIELD

The present disclosure relates to timing control of relay station controlled by network.

### BACKGROUND ART

The number, types, and applications of wireless communication devices (hereinafter also collectively referred to as communication devices or UEs (User Equipments)), represented by smartphones and Internet of Things (IoT) devices, continue to increase, and wireless communication standards continue to be expanded and improved. For example, the commercial service of the fifth generation mobile communication system known as “5G” started in 2018, and the standards are still being developed by the 3GPP (Third Generation Partnership Project). Efforts are also underway to develop standards for “6G” or the sixth generation mobile communication system, which would be the next generation of wireless communication standards following 5G.

In a mobile communication network, communication is performed between a radio access network (RAN), which includes various types of base stations, such as terrestrial base stations fixedly installed on the ground and non-terrestrial base stations such as communication satellites, and a UE. Relay stations are sometimes utilized to relay downlink communication and uplink communication between the RAN and the UE in order to expand each communication cell provided by each base station or to improve communication quality.

### RELATED-ART LITERATURE

### Patent Literature

Patent Literature 1: JP-A-2010-278886

### SUMMARY OF THE INVENTION

### Technical Problem

In particular, a relay station (hereinafter also referred to as NCR (Network-Controlled Repeater or Network-Controlled Relay Station)) controllable by the RAN and/or the core network (hereinafter also collectively referred to as radio access network, RAN, network, and the like) can be utilized to improve the relay quality between the RAN and the UE. On the other hand, by making the NCR controllable by the network, processing delays occur in the NCR in order to perform processing based on control information from the network.

In a TDD (Time Division Duplex) mobile communication, in which a downlink communication (i.e., communication relayed by the NCR with the RAN as the transmitter and the UE as the receiver) and an uplink communication (i.e., communication relayed by the NCR with the UE as the transmitter and the RAN as the receiver) in the RAN, the NCR, and the UE are divided in time, the timing of transmission and reception in the NCR may not match the prescribed timing of transmission and reception by the TDD due to the processing delays, especially in the uplink communication.

The present disclosure was made in consideration of this situation, and its purpose is to provide a communication control apparatus and the like that can appropriately control the communication timing of a relay station controlled by a network.

### Solution to Problem

In order to solve the above issue, a communication control apparatus in a certain aspect of the present disclosure controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a timing controller, controlling an uplink transmission timing of the relay station to the radio access network in the relay of the uplink communication to be after the timing at which an uplink processing delay of the relay station in the relay is added to an uplink reception timing of the relay station from the communication device in the relay.

Another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a timing controller, controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

Further another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a communication controller, delaying the uplink communication by the relay station to the radio access network until the further next uplink transmission timing in the time division duplex, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Further another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a communication controller, causing the relay station to perform the uplink communication to the radio access network by using at least one flexible symbol allocated to an uplink symbol, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Further another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a communication controller, increasing the number of uplink symbols allocated to an uplink reception timing and an uplink transmission timing of the relay station in the relay of the uplink communication, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Further another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a communication controller, adjusting a downlink processing delay of the relay station in the relay of the downlink communication, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Further another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a communication controller, imposing an upper limit on an uplink processing delay of the relay station in the relay of the uplink communication.

Further another aspect of the present disclosure is also a communication control apparatus. The apparatus controls by time division duplex a communication network comprising a radio access network, a communication device capable of communicating with the radio access network, and a relay station that relays downlink communication and uplink communication between the radio access network and the communication device under the control of the radio access network, and includes at least one processor that performs, by a processing delay sharing device, sharing from the relay station to the radio access network, at least one of a downlink processing delay of the relay station in the relay of the downlink communication and an uplink processing delay of the relay station in the relay of the uplink communication.

Further another aspect of the present disclosure is a communication control method. The method controls by time division duplex a communication network comprising a radio access network, a communication device capable of communicating with the radio access network, and a relay station that relays downlink communication and uplink communication between the radio access network and the communication device under the control of the radio access network, and includes controlling an uplink transmission timing of the relay station to the radio access network in the relay of the uplink communication to be after the timing at which an uplink processing delay of the relay station in the relay is added to an uplink reception timing of the relay station from the communication device in the relay.

Further another aspect of the present disclosure is also a communication control method. The method controls by time division duplex a communication network comprising a radio access network, a communication device capable of communicating with the radio access network, and a relay station that relays downlink communication and uplink communication between the radio access network and the communication device under the control of the radio access network, and includes controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

Further another aspect of the present disclosure is a computer-readable medium. The computer-readable medium stores a communication control program that controls by time division duplex a communication network comprising a radio access network, a communication device capable of communicating with the radio access network, and a relay station that relays downlink communication and uplink communication between the radio access network and the communication device under the control of the radio access network, wherein the communication control program causes a computer to perform controlling an uplink transmission timing of the relay station to the radio access network in the relay of the uplink communication to be after the timing at which an uplink processing delay of the relay station in the relay is added to an uplink reception timing of the relay station from the communication device in the relay.

Further another aspect of the present disclosure is a computer-readable medium. The computer-readable medium stores a communication control program that controls by time division duplex a communication network comprising a radio access network, a communication device capable of communicating with the radio access network, and a relay station that relays downlink communication and uplink communication between the radio access network and the communication device under the control of the radio access network, wherein the communication control program causes a computer to perform controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

In addition, any combination of the above components, and any conversion of the expression of the present disclosure among methods, devices, systems, recording media, computer programs, and the like are also encompassed within this disclosure.

### Advantageous Effects of Invention

According to the present disclosure, the communication timing of a relay station controlled by a network can be appropriately controlled.

### BRIEF DESCRIPTION OF DRAWINGS

FIG. 1 schematically shows the overview of a wireless communication system to which the communication control apparatus is applied.

FIG. 2 is a functional block diagram of the communication control apparatus.

FIG. 3 schematically shows an example of timing control by a timing controller.

FIG. 4 schematically shows an example of slot format change by a communication controller.

### DESCRIPTION OF EMBODIMENTS

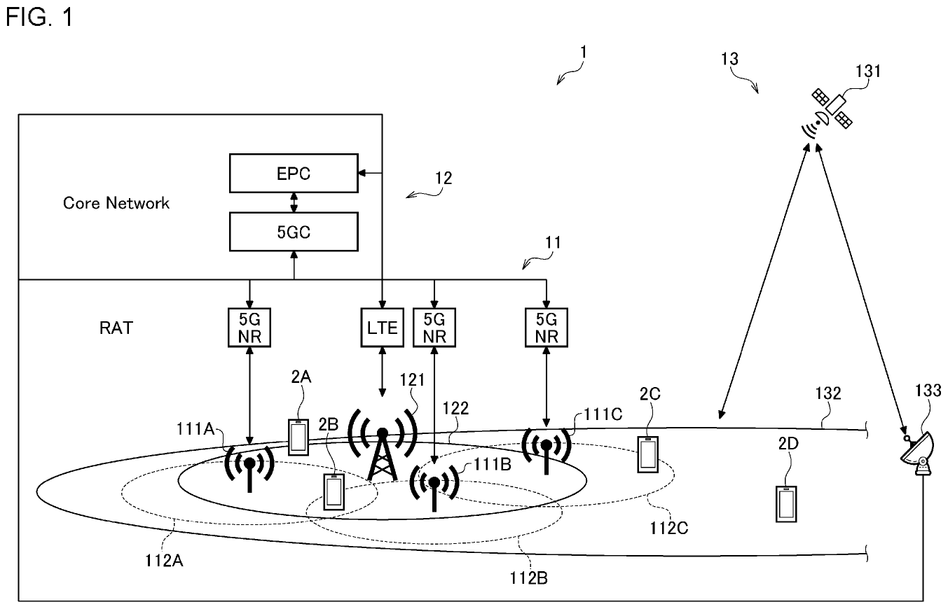

FIG. 1 schematically shows an overview of a wireless communication system 1 to which the communication control apparatus according to an embodiment of the present disclosure is applied. The wireless communication system 1 includes a 5G wireless communication system 11, a 4G wireless communication system 12, and a satellite communication system 13. The 5G wireless communication system 11 that complies with the fifth generation mobile communication system (5G) uses NR (New Radio) or 5G NR (Fifth Generation New Radio) as the radio access technology (RAT) and 5GC (Fifth Generation Core) as the core network. The 4G wireless communication system 12 that complies with the fourth generation mobile communication system (4G) uses LTE (Long Term Evolution) or LTE-Advanced as the radio access technology and EPC (Evolved Packet Core) as the core network. The satellite communication system 13 is for satellite communication via communication satellite 131. Although not shown in the figure, the wireless communication system 1 may include wireless communication networks of a generation prior to 4G, a generation later than 5G (such as 6G), or any wireless communication networks that are not associated with generations, such as Wi-Fi (registered trademark).

The 5G wireless communication system 11 may include a plurality of 5G base stations 111A, 111B, and 111C (hereinafter also collectively referred to as 5G base station 111) installed on the ground capable of communicating by 5G NR with communication devices 2A, 2B, 2C, and 2D (hereinafter also collectively referred to as communication device(s) 2) such as smartphones, which are also referred to as UE (User Equipment). The 5G base station 111 is also referred to as gNodeB (gNB). The coverage or support range of each 5G base station 111A, 111B and 111C is referred to as a cell 112A, 112B and 112C (hereinafter also collectively referred to as 5G cell 112).

The size of the 5G cell 112 of each 5G base station 111 is freely selected, but typically ranges from a few meters to several tens of kilometers in radius. Although there is no established definition, cells with a radius of a few meters to ten meters are called femtocells, cells with a radius of ten meters to several tens of meters are called picocells, cells with a radius of several tens of meters to several hundred meters are called microcells, and cells with a radius of more than several hundreds of meters are called macrocells. In 5G, high frequency radio waves such as millimeter waves are often used, and their high tendency to propagate in a straight-line causes radio waves to be blocked by obstacles, shortening the communication distance. For this reason, 5G tends to use more small cells than 4G and earlier generations.

The communication device 2 can conduct 5G communication when it is located within at least one of a plurality of 5G cells 112A, 112B and 112C. In the example shown in the figure, communication device 2B in 5G cells 112A and 112B can communicate with both 5G base stations 111A and 111B by 5G NR. In addition, the communication device 2C in the 5G cell 112C can communicate with the 5G base station 111C by 5G NR. Communication device 2A and 2D are outside of all 5G cells 112A, 112B and 112C, so they are not able to communicate by 5G NR. The 5G NR-based 5G communication between each communication device 2 and each 5G base station 111 is managed by the 5GC, which is the core network. For example, the 5GC transfers data to and from each 5G base station 111, transfers data to and from external networks such as the EPC, the satellite communication system 13 and the Internet, and manages the movement of the communication device 2.

The 4G wireless communication system 12 includes a plurality of 4G base stations 121 (only one of them is shown in FIG. 1) installed on the ground that can communicate with the communication device 2 by LTE or LTE-Advanced. The base station 121 in 4G is referred to as eNodeB (eNB). Similar to each 5G base station 111, the communication range or support range of each 4G base station 121 is also called a cell and is shown as 122.

The communication device 2 can conduct 4G communication when it is located within 4G cell 122. In the example shown in the figure, the communication devices 2A and 2B in the 4G cell 122 can communicate with the 4G base station 121 by LTE or LTE-Advanced. Communication device 2C and 2D are outside the 4G cell 122 and are not able to communicate by LTE or LTE-Advanced. The 4G communication by LTE and LTE-Advanced between each communication device 2 and each 4G base station 121 is managed by the EPC, which is the core network. For example, the EPC manages the transfer of data to and from each 4G base station 121, the transfer of data to and from external networks such as 5GC, the satellite communication system 13 and the Internet, and the movement management of the communication device 2.

If we take a look at each communication device 2A, 2B, 2C and 2D in the example shown in the figure, the communication device 2A is in a state that enables 4G communication with 4G base station 121, and communication device 2B is in a state that enables 5G communication with 5G base stations 111A and 111B and 4G communication with 4G base station 121, and communication device 2C is in a state that enables 5G communication with 5G base station 111C. When there are multiple base stations (111A, 111B and 121) as in the case of communication device 2B, one base station is selected as the most suitable for the communication device 2B in terms of communication quality and the like, under the control of the 5GC and/or the EPC, which is the core network. For the communication device 2D that is not in a state that enables 5G communication with any 5G base station 111 or 4G communication with any 4G base station 121, the communication is conducted using the satellite communication system 13 described below.

The satellite communication system 13 is the wireless communication system using communication satellites 131 as non-terrestrial base stations. The communication satellites 131 are low-earth-orbit satellites flying in low-earth-orbit outer space of 500 to 700 km above the ground. Similar to 5G base station 111 and 4G base station 121, the communication range or support range of each communication satellite 131 is also called a cell and is shown as 132. Thus, a communication satellite 131 as a non-terrestrial base station provides a satellite communication cell 132 as a non-terrestrial communication cell onto the ground. Communication device 2 on the ground can conduct satellite communication when it is inside the satellite communication cell 132. Similar to 5G base station 111 in the 5G wireless communication system 11 and 4G base station 121 in the 4G wireless communication system 12, communication satellite 131 as the base station in the satellite communication system 13 is capable of wireless communication directly or indirectly via aircraft and the like with the communication device 2 within the satellite communication cell 132. The radio access technology used by the communication satellite 131 for wireless communication with the communication device 2 in the satellite communication cell 132 may be 5G NR, the same as the 5G base station 111, or LTE or LTE-Advanced, the same as the 4G base station 121, or any other radio access technology that the communication device 2 can use. Therefore, there is no need for the communication device 2 to have any special functions or components for satellite communication.

The satellite communication system 13 is equipped with a gateway 133 as a ground station that is installed on the ground and can communicate with the communication satellite 131. The gateway 133 is equipped with a satellite antenna to communicate with the communication satellite 131, and is connected to the 5G base station 111 and the 4G base station 121 as terrestrial base stations that constitute the terrestrial network (TN). In this way, the gateway 133 connects the non-terrestrial network (NTN), which is including communication satellites 131 as a non-terrestrial base station or a satellite base station, and the terrestrial network TN, which includes terrestrial base stations 111 and 121, for mutual communication. When the communication satellite 131 conducts 5G communication with the communication device 2 in the satellite communication cell 132 by 5G NR, the 5GC connected via the gateway 133 and the 5G base station 111 in the TN (or the 5G radio access network) is used as the core network. When the communication satellite 131 conducts 4G communication with the communication device 2 in the satellite communication cell 132 by LTE or LTE-Advanced, the EPC connected via the gateway 133 and the 4G base station 121 in the TN (or the 4G radio access network) is used as the core network. In this way, appropriate coordination is made between different wireless communication systems such as 5G wireless communication system 11, 4G wireless communication system 12, satellite communication system 13 and the like through the gateway 133.

Satellite communication by communication satellites 131 is mainly used for covering areas with no or few terrestrial base stations such as 5G base stations 111, 4G base stations 121, and the like. In the example shown in the figure, a communication device 2D that is outside the communication cells of all the terrestrial base stations communicates with the communication satellite 131. On the other hand, communication devices 2A, 2B, and 2C that are in good communication with either of the terrestrial base stations, are also in the satellite communication cell 132 and can communicate with the communication satellite 131. However, by communicating with the terrestrial base stations instead of the communication satellite 131 as the satellite base station in principle, the limited communication resources (including power) of the communication satellite 131 are saved for the communication device 2D and the like. The communication satellite 131 uses beamforming to direct the communication radio wave to the communication device 2D in the satellite communication cell 132, thereby the communication quality with the communication device 2D is improved.

The size of the satellite communication cell 132 of the communication satellite 131 as a satellite base station depends on the number of beams emitted by the communication satellite 131. For example, a satellite communication cell 132 with a diameter of about 24 km can be formed by combining up to 2,800 beams. As illustrated, a satellite communication cell 132 is typically larger than a terrestrial communication cell such as a 5G cell 112 or a 4G cell 122, and could contain one or more 5G cells 112 and/or 4G cells 122 inside it. The above example shows a communication satellite 131 flying in low-earth-orbit outer space at a height of about 500 km to 700 km above the ground as a flying non-terrestrial base station. However, a communication satellite flying in geostationary orbit or other higher orbit in outer space, or an unmanned or manned aircraft or a drone flying in stratosphere or other lower (e.g., about 20 km above the ground) atmosphere may be used as a non-terrestrial base station in addition to or instead of the communication satellite 131.

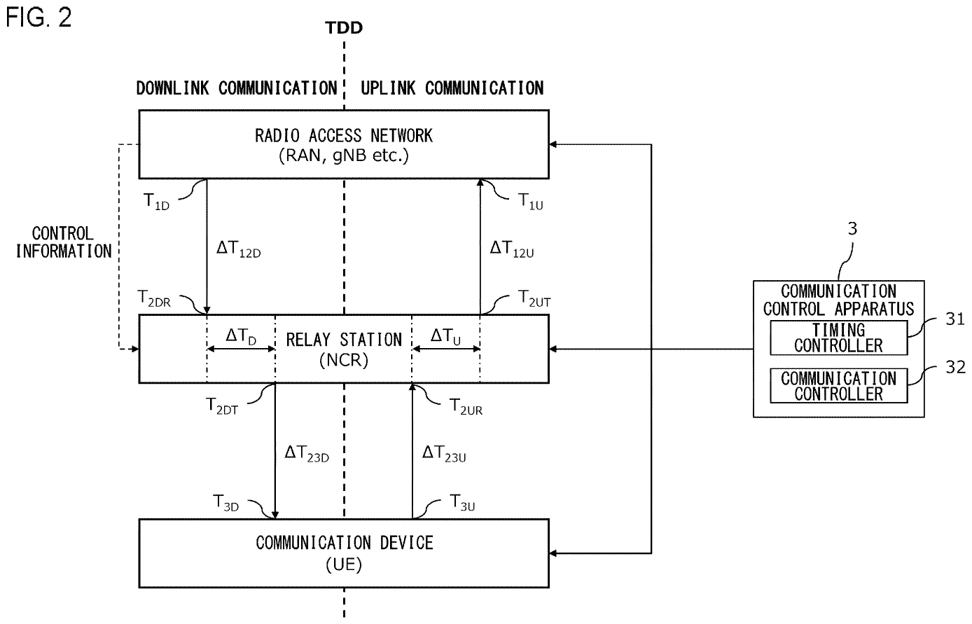

FIG. 2 is a functional block diagram of a communication control apparatus 3 according to the present embodiment. The communication control apparatus 3 includes a timing controller 31 and a communication controller 32. Some of these functional blocks can be omitted as long as the communication control apparatus 3 realizes at least some of the operations and/or effects described below. These functional blocks are realized by the cooperation of hardware resources, such as the central processing unit, memory, input devices, output devices, and peripheral devices connected to the computer, and software that is executed using them. Regardless of the type of computer or its installation location, each of the above functional blocks may be realized with the hardware resources of a single computer, or by combining hardware resources distributed across multiple computers. Especially in the present embodiment, some or all of functional blocks of the communication control apparatus 3 may be realized in a centralized or distributed manner by computer and/or processor provided in the communication device 2 (UE), the relay station (NCR), the base station 111, 121, 131 configuring the RAN, the gateway 133, and the core network.

The main control target of the communication control apparatus 3 according to the present embodiment is at least one of the radio access network (RAN), the relay station (NCR), and the communication device (UE). It should be noted that, in the following, the gNB (the 5G base station 111) is illustrated as a representative configuration of the RAN. The following description for the gNB applies equally to any other base station, such as the 4G base station 121 (eNB) or the communication satellite 131.

The relay station (NCR) is a repeater that relays downlink communication and uplink communication between the gNB (the radio access network) and the UE under the control of the network (the RAN and/or the core network). The NCR decodes control information from the network, and performs processing such as communication timing control on a symbol-by-symbol basis, communication beam control such as beamforming, and on/off control of communication resources.

The downlink communication is a communication relayed by the NCR with the gNB as the transmitter and the UE as the receiver. The uplink communication is a communication relayed by the NCR with the UE as the transmitter and the gNB as the receiver. In the present embodiment, the downlink communication and the uplink communication are performed using the Time Division Duplex (TDD) method. In the TDD mobile communication, the transmission timing and the reception timing and/or the downlink communication timing and the uplink communication timing are divided in time, in the gNB, the NCR, and the UE performing communication (transmission and reception) respectively. Thus, the communication control apparatus 3 according to the present embodiment controls by time division duplex the communication network including the gNB (the radio access network), the UE (the communication device) capable of communicating with the qNB, and the NCR (the relay station) that relays the downlink communication and the uplink communication between the gNB and the UE under the control of the gNB.

In the downlink communication, the gNB as the transmitter transmits one or more communication units (communication data) to the NCR and/or the UE at the prescribed downlink transmission timing T_{1D}. The examples of the communication unit include the frame, the subframe, the slot, the symbol, and the like. In the following examples, the frame is mainly used as the communication unit.

The NCR as a relay station receives one or more downlink frames transmitted by the gNB at T_{ID}, at the downlink reception timing T_{2DR}. Here, “T_{2DR}-T_{1D}” is the propagation delay ΔT_{12D} between the gNB and the NCR in the downlink communication. The NCR processes the downlink frames received from the gNB at T_{2DR} based on the control information from the gNB. This causes the downlink processing delay ΔT_{D} in the NCR. The downlink processing delay ΔT_{D} defines the upper limit of the time within which the processing of the downlink frame in the NCR should be completed. That is, the processing of the downlink frame in the NCR should be completed before the downlink processing delay ΔT_{D} elapses from T_{2DR}. In other words, the downlink processing delay ΔT_{D} can be set to any time longer than the time Δt_{D} (hereinafter uniformly denoted as ΔT_{D} unless it needs to be specifically distinguished from ΔT_{D}) required for the actual processing of the downlink frame in the NCR. However, as described below, the downlink processing delay ΔT_{D} and/or the downlink transmission timing T_{2DT} can be adjusted to properly control the communication timing of the NCR.

The NCR transmits the processed downlink frame to the UE at the prescribed downlink transmission timing T_{2DT} after the downlink processing delay ΔT_{D} elapses. Here, “T_{2DT}-T_{2DR}” is equal to the downlink processing delay ΔT_{D}. The UE as the receiver in the downlink communication, receives one or more downlink frames transmitted by the NCR at T_{2DT}, at the downlink reception timing T3_{D}. Here, “T_{3D}-T_{2DT}” is the propagation delay ΔT_{23D} between the NCR and the UE in the downlink communication.

In the uplink communication, the UE as the transmitter transmits one or more uplink frames to the NCR and/or the gNB at the prescribed uplink transmission timing T3_{U}, typically in response to the downlink frame received at T_{3D}.

The NCR as a relay station receives one or more uplink frames transmitted by the UE at T_{3U}, at the uplink reception timing T_{2UR}. Here, “T_{2UR}-T_{3U}” is the propagation delay ΔT_{23U} between the UE and the NCR in the uplink communication. The NCR processes the uplink frame received from the UE at T_{2UR} based on the control information from the gNB. This causes the uplink processing delay ΔT_{U} in the NCR. The uplink processing delay ΔT_{U} defines the upper limit of the time within which the processing of the uplink frame in the NCR should be completed. That is, the processing of the uplink frame in the NCR should be completed before the uplink processing delay ΔT_{U} elapses from T_{2UR}. In other words, the uplink processing delay ΔT_{U} can be set to any time longer than the time Δt_{U} (hereinafter uniformly denoted as ΔT_{U} unless it needs to be specifically distinguished from ΔT_{U}) required for the actual processing of the uplink frame in the NCR. However, as described below, the uplink processing delay ΔT_{U} and/or the uplink transmission timing T_{2UT} can be adjusted to properly control the communication timing of the NCR.

The NCR transmits the processed uplink frame to the gNB at the prescribed uplink transmission timing T_{2UT} after the uplink processing delay ΔT_{U} elapses. Here, “T_{2UT}-T_{2UR}” is equal to the uplink processing delay ΔT_{U}. The gNB as the receiver in the uplink communication, receives one or more uplink frames transmitted by the NCR at Tur, at the uplink reception timing Tiu. Here, “T_{1U}-T_{2UT}” is the propagation delay ΔT_{12U} between the NCR and the gNB in the uplink communication.

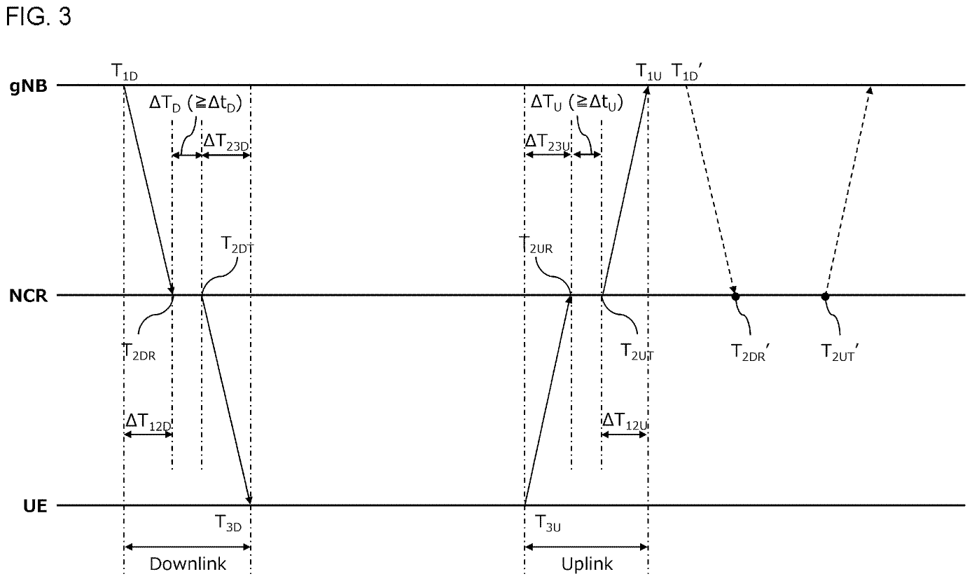

The timing controller 31 controls the uplink transmission timing T_{2UT} of the NCR (the relay station) to the gNB (the radio access network) in the relay of the uplink communication. FIG. 3 schematically shows an example of timing control by the timing controller 31.

As described above with respect to FIG. 2, in the downlink communication, the gNB as the transmitter transmits the downlink communication data to the NCR at the prescribed downlink transmission timing T_{1D}. The NCR receives the downlink communication data transmitted by the gNB at T_{1D}, at the downlink reception timing T_{2DR}. The NCR transmits to the UE the downlink communication data processed based on the control information from the gNB, at the prescribed downlink transmission timing T_{2DT} after the downlink processing delay ΔT_{D} elapses. The UE as the receiver in the downlink communication, receives the downlink communication data transmitted by the NCR at T_{2DT}, at the downlink reception timing T_{3D}.

In the uplink communication, the UE as the transmitter transmits the uplink communication data to the NCR at the prescribed uplink transmission timing T_{3U}. The NCR receives the uplink communication data transmitted by the UE at T_{3U}, at the uplink reception timing T_{2UR}. The NCR transmits to the gNB the uplink communication data processed based on the control information from the gNB, at the prescribed uplink transmission timing T_{2UT} after the uplink processing delay ΔT_{U} elapses. The gNB as the receiver in the uplink communication, receives the uplink communication data transmitted by the NCR at T_{2UT}, at the uplink reception timing T_{1U}.

In the downlink communication and the uplink communication as described above, the transmission timing and the reception timing of communication data in the gNB, the NCR, and the UE, respectively, are determined in advance by time division in accordance with the TDD method. For example, the transmission/reception timing or the transmission/reception period for the gNB, the NCR, and the UE, respectively, are set through the random access procedure performed on the Random Access Channel (RACH) for the initial connection establishment. In the present embodiment where the NCR exists between the gNB and the UE, the random access procedure is performed not only between the gNB and the UE, but also between the gNB and the NCR.

In the random access procedure between the gNB and the NCR, messages for initial connection establishment are exchanged between the gNB and the NCR. In the process, the propagation delay between the gNB and the NCR (e. g., Δ T_{12D}, ΔT_{12U}, ΔT_{12D}+ΔT_{12U} (round-trip time: RTT) ) is recognized, and the transmission timing T_{2UT} in the NCR is appropriately set considering such propagation delay. Typically, since the uplink reception timing T_{1U} in the gNB is predetermined, the uplink transmission timing T_{2UT} in the NCR is made earlier than T_{1U}, by the uplink propagation delay ΔT_{12U} (or the average of ΔT_{12D} and ΔT_{12U}) between the NCR and the gNB, so that the gNB can properly receive the uplink frame from the NCR at the desired timing Tiu. Besides, the gNB takes into account the downlink propagation delay ΔT_{12D} (or the average of ΔT_{12D} and ΔT_{12U}) between the gNB and the NCR in transmitting each downlink frame to the NCR at the appropriate downlink transmission timing T_{1D}, so that the NCR can receive the downlink frame from the gNB at the desired downlink reception timing T_{2DR}.

It should be noted that the actual downlink processing delay Δt_{D} and/or uplink processing delay Δt_{U} in the NCR may be measured and shared with the gNB, by the random access procedure, another procedure, or any communication between the gNB and the NCR. In other words, the NCR may include a processing delay sharing device that shares the actual downlink processing delay Δt_{D} and/or uplink processing delay Δt_{U} with the gNB, and the gNB may include a processing delay acquisition device that acquires the actual downlink processing delay Δt_{D} and/or uplink processing delay Δt_{U} from the NCR. As mentioned above, each processing delay ΔT_{D} and ΔT_{U}, which is the time difference between each reception timing T_{2DR} and T_{2UR} and each transmission timing T_{2DT} and T_{2UT} in the NCR, is set to be longer than each actual processing delay Δt_{D} and Δt_{U}.

In the random access procedure between the gNB and the UE, messages for initial connection establishment are exchanged between the gNB and the UE via the NCR. In the process, the propagation delay between the gNB and the UE is recognized, and the transmission timing and/or the reception timing in the gNB and the UE are appropriately set considering such propagation delay. Here, the propagation delay between the gNB and the UE includes the actual processing delay Δt_{D} and Δt_{U} in the intervening NCR in addition to the exact propagation delay. Therefore, the downlink propagation delay recognized in the random access procedure between the gNB and the UE is ΔT_{12D}+Δt_{D}+ΔT_{23D}, and the uplink propagation delay recognized in the random access procedure between the gNB and the UE is ΔT_{23U}+Δt_{U}+ΔT_{12U}. However, the gNB can recognize the propagation delay ΔT_{12D} and ΔT_{12U} between the gNB and the NCR, or the actual processing delay Δt_{D} and Δt_{U} in the NCR, through the aforementioned random access procedure with the NCR, and the like. Therefore, the gNB can indirectly recognize the propagation delay between the NCR and the UE (e.g., ΔT_{23D}, ΔT_{23U}, ΔT_{23D}+ΔT_{23U} (round trip time: RTT)). It should be noted that the presence of the NCR is not recognized from the UE's point of view. Therefore, the UE acts as if it is communicating directly with the gNB, and recognizes each of the above propagation delays ΔT_{12D}+Δt_{D}+ΔT_{23D} and ΔT_{23U}+Δt_{U}+ΔT_{12U} as each propagation delay with the gNB.

Through such random access procedure between the gNB and the UE, the uplink transmission timing T_{3U} in the UE is made earlier than the uplink reception timing T_{2UR} in the NCR by ΔT_{23U}, considering the uplink propagation delay ΔT_{23U} (or the average of ΔT_{23D} and ΔT_{23U}) between the UE and the NCR recognized by the gNB. Besides, the gNB takes into account the downlink propagation delay ΔT_{12D} (or the average of ΔT_{12D} and ΔT_{12U}) between the gNB and the NCR, the downlink processing delay ΔT_{D}, and the downlink propagation delay ΔT_{23D} (or the average of ΔT_{23D} and ΔT_{23U}) between the NCR and the UE, in transmitting each downlink frame to the NCR (and the UE) at the appropriate downlink transmission timing TID, so that the UE can receive the downlink frame transmitted by the NCR at the desired downlink transmission timing T_{2DT}, at the desired downlink reception timing T_{3D}.

The timing controller 31 controls the uplink transmission timing T_{2UT} of the NCR (the relay station) to the gNB (the radio access network) in the relay of the uplink communication.

Specifically, the timing controller 31 controls the uplink transmission timing T_{2UT} in the NCR to be after the timing at which the actual uplink processing delay Δt_{U} in the NCR is added to the uplink reception timing T_{2UR} in the NCR from the UE in the same uplink communication cycle. In other words, starting from the uplink reception timing T_{2UR} in the NCR, the uplink transmission timing T_{2UT} in the NCR is set after the actual uplink processing delay Δt_{U} has elapsed. This can be expressed in a mathematical formula: T_{2UT}=T_{2UR}+ΔT_{U}≥T_{2UR}+Δt_{U} (i.e., ΔT_{U} is set by the timing controller 31 such that ΔT_{U}≥Δt_{U}). If the timing controller 31 sets the uplink transmission timing T_{2UT} that can satisfy such condition, the NCR can process the uplink communication data received at the uplink reception timing T_{2UR} based on the control information from the gNB, and then transmit it at the uplink transmission timing T_{2UT} in the same uplink communication cycle. Since the NCR does not need to wait until the next uplink communication cycle, it can relay the uplink communication efficiently.

Besides, the timing controller 31 controls the uplink transmission timing T_{2UT} in the NCR to be before the timing at which the propagation delay between the NCR and the gNB is subtracted from the next downlink reception timing T_{2DR}′ in the NCR from the gNB in the next downlink communication cycle in accordance with the TDD method. In the case, the propagation delay between the NCR and the gNB is preferably the round-trip propagation delay between the NCR and the gNB (i.e., ΔT_{12U}+ΔT_{12D}). This can be expressed in a mathematical formula: T_{2UT}≤T_{2DR}′−(ΔT_{12U}+ΔT_{12D}). If the timing controller 31 sets the uplink transmission timing T_{2UT} that can satisfy such condition, a time margin is created for the gNB to prepare the downlink communication data to be transmitted at the immediately following (next) downlink transmission timing T_{1D}′ in response to the uplink communication data received at the uplink reception timing T_{1U} (i.e., T_{1U}≤T_{1D}′) . Therefore, communication between the gNB and the UE can be performed efficiently even if the NCR intervenes.

The communication controller 32 deals with the case where there is no T_{2UT} that can satisfy the above condition, specifically, T_{2UR}+Δt_{U}=T_{2UT}=T_{2UR}+ΔT_{U}=T_{2DR}′−(ΔT_{12U}+ΔT_{12D}), that is, the case where T_{2UR}+Δt_{U}>T_{2DR}′−(ΔT_{12U}+ΔT_{12D}). In such a case, the NCR cannot process the uplink communication data received at the uplink reception timing T_{2UR} based on the control information from the gNB, let alone transmit it at the uplink transmission timing T_{2UT} in the same uplink communication cycle. Or, the time margin cannot be created for the gNB to prepare the downlink communication data to be transmitted at the immediately following (next) downlink transmission timing T_{1D}′ in response to the uplink communication data received at the uplink reception timing T_{1U}. Therefore, the communication controller 32 performs various communication controls, including those exemplarily listed below. It should be noted that the communication controller 32 may impose an upper limit on the actual uplink processing delay Δt_{U} in the NCR so that the above condition “T_{2UR}+Δt_{U}≤T_{2UT}=T_{2UR}+ΔT_{U}≤T_{2DR}′−(ΔT_{12U}+ΔT_{12D})” is substantially always satisfied. Besides, the communication controller 32 may have the NCR notify the gNB of the fact that the above condition is not satisfied.

If the NCR cannot transmit the uplink communication data received at the uplink reception timing T_{2UR} at the uplink transmission timing T_{2UT} in the same uplink communication cycle, the communication controller 32 may delay the uplink communication by the NCR to the gNB until the further next uplink transmission timing T_{2UT}′ in the TDD.

If the NCR cannot transmit the uplink communication data received at the uplink reception timing T_{2UR} at the uplink transmission timing T_{2UT} in the same uplink communication cycle, the communication controller 32 may cause the NCR to perform the uplink communication to the gNB by using at least one flexible symbol allocated to an uplink symbol through the control signal given from the NCR to the qNB, for example. In 5G, the configuration of a slot including 14 OFDM symbols can be set to include a flexible symbol. The flexible symbols are symbols that can be used for both the uplink communication and the downlink communication.

In the example shown in the figure, at least one of the slots available during the downlink communication cycle, which is roughly classified in accordance with the TDD method, can be set to include a flexible symbol, so that the uplink communication can be performed as necessary even during the downlink communication cycle in which the downlink communication is mainly performed. Then, the uplink communication data that could not be transmitted in time for the earliest preferable uplink transmission timing T_{2UT} (during the uplink communication cycle), can be transmitted using the flexible symbol allocated to the uplink symbol in the immediately following (next) downlink communication cycle. The uplink communication can be relayed efficiently because there is no need for the NCR to wait until the next uplink communication cycle. It should be noted that, if the NCR can transmit the uplink communication data received at the uplink reception timing T_{2UR} at the uplink transmission timing T_{2UT} in the same uplink communication cycle, the flexible symbols in the next downlink communication cycle are preferably allocated to the downlink symbols.

If the NCR cannot transmit the uplink communication data received at the uplink reception timing T_{2UR} at the uplink transmission timing T_{2UT} in the same uplink communication cycle, the communication controller 32 may increase the number of the uplink symbols allocated to the uplink reception timing T_{2UR} and the uplink transmission timing T_{2UT} of the NCR in the relay of the uplink communication. For example, taking advantage of the flexibility in 5G to change the configuration or the format of slots including 14 OFDM symbols, the format of slots at the uplink reception timing T_{2UR} and the uplink transmission timing T_{2UT} of the NCR, may be changed to the one having the large number or ratio of the uplink symbols.

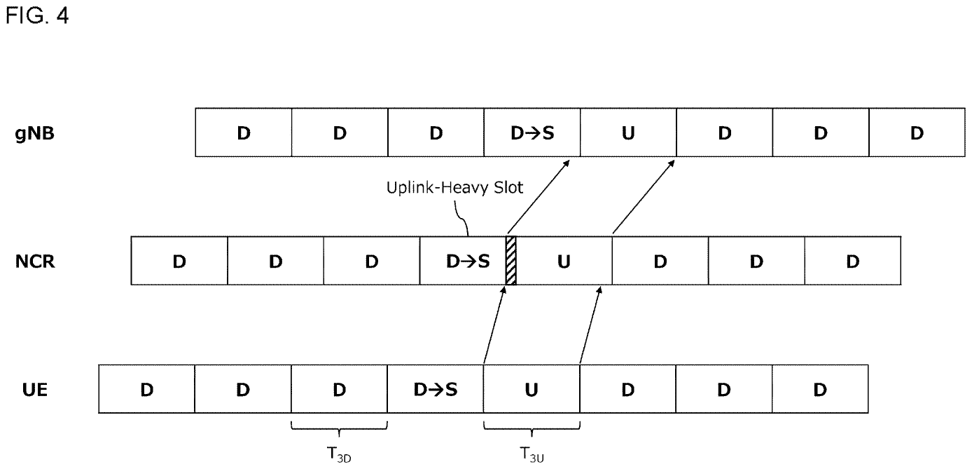

FIG. 4 schematically shows an example of changing the format of slots by the communication controller 32. In the figure, “D” is the downlink slot with SFI (Slot Format Indicator) “0” in which all 14 OFDM symbols are downlink symbols, “U” is the uplink slot with SFI “1” in which all 14 OFDM symbols are uplink symbols, and “S” is the special slot (e.g., with any of SFI “2” to “55”) that includes at least two types of symbols among the downlink symbol, the uplink symbol, and the aforementioned flexible symbol.

In FIG. 4, the UE receives the downlink slot “D” from the NCR at the downlink reception timing T_{3D}. The UE then transmits the uplink slot “U” to the NCR at the uplink transmission timing T_{3U}. However, if the above condition “T_{2UR}+Δt_{U}≤T_{2UT}=T_{2UR}+ΔT_{U}≤T_{2DR}′−(ΔT_{12U}+ΔT_{12D})” is not satisfied, at least a portion of the uplink slot “U” transmitted by the UE at the uplink transmission timing T_{3U} may be received, not at the corresponding uplink slot “U” in the NCR, but at the downlink slot “D” before it. Since only the downlink communication is allowed in the downlink slot “D”, the NCR cannot properly receive or process at least a portion of the uplink slot “U” from the UE.

Therefore, as indicated by “D→S” in FIG. 4, the communication controller 32 changes the corresponding downlink slot “D” between the downlink reception timing T_{3D} and the uplink transmission timing T_{3U}, to the special slot “S” (Uplink-Heavy Slot) with at least one uplink symbol, preferably more than half (7 symbols in 5G) of which is occupied by the uplink symbols. The uplink symbol included in such a special slot “S” allows the NCR to properly receive and process the uplink slot “U” that arrives from the UE earlier (than the desired uplink slot “U”) as shown in the example of FIG. 4.

If the NCR cannot transmit the uplink communication data received at the uplink reception timing TOUR at the uplink transmission timing Taur in the same uplink communication cycle, the communication controller 32 may adjust the downlink processing delay ΔT_{D} of the NCR in the relay of the downlink communication. By adjusting the downlink processing delay ΔT_{D}, the uplink transmission timing T_{3U} in the UE and/or the uplink reception timing T_{2UR} in the NCR can be adjusted indirectly. In particular, by increasing the downlink processing delay ΔT_{D}, the apparent propagation delay between the gNB and the UE increases, so the uplink transmission timing T_{3U} in the UE is automatically adjusted to be earlier, resulting in the earlier uplink reception timing T_{2UR} in the NCR. Thus, since T_{2UR} becomes earlier (smaller), room is created to set T_{2UT} that satisfies the above condition “T_{2UR}+Δt_{U}≤T_{2UT}=T_{2UR}+ΔT_{U}≤T_{2DR}′−(ΔT_{12U}+ΔT_{12D})”. With such an uplink transmission timing T_{2UT} set by the timing controller 31, the NCR can process the uplink communication data received at the adjusted uplink reception timing T_{2UR} based on the control information from the gNB, and then can transmit it at the uplink transmission timing T_{2UT} in the same uplink communication cycle.

The present disclosure has been described above based on embodiments. It is obvious to those skilled in the art that various variations are possible in the combination of each component and/or each process in the exemplary embodiments, and that such variations are also encompassed within the scope of the present disclosure.

It should be noted that the structures, the operations, and the functions of each apparatus and/or each method described in the embodiments can be realized by hardware resources or software resources, or by the cooperation of hardware resources and software resources. As hardware resources, for example, processors, ROMs, RAMs and various integrated circuits can be used. As software resources, for example, programs such as operating systems and applications can be used.

The present disclosure may be expressed as the following items.

Item 1: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a timing controller, controlling an uplink transmission timing of the relay station to the radio access network in the relay of the uplink communication to be after the timing at which an uplink processing delay of the relay station in the relay is added to an uplink reception timing of the relay station from the communication device in the relay.

Item 2: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a timing controller, controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

Item 3: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, delaying the uplink communication by the relay station to the radio access network until the further next uplink transmission timing in the time division duplex, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Item 4: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, causing the relay station to perform the uplink communication to the radio access network by using at least one flexible symbol allocated to an uplink symbol, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Item 5: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, increasing the number of uplink symbols allocated to an uplink reception timing and an uplink transmission timing of the relay station in the relay of the uplink communication, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Item 6: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, adjusting a downlink processing delay of the relay station in the relay of the downlink communication, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

Item 7: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, imposing an upper limit on an uplink processing delay of the relay station in the relay of the uplink communication.

Item 8: A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a processing delay sharing device, sharing from the relay station to the radio access network, at least one of a downlink processing delay of the relay station in the relay of the downlink communication and an uplink processing delay of the relay station in the relay of the uplink communication.

Item 9: A communication control method that controls by time division duplex a communication network comprising a radio access network, a communication device capable of communicating with the radio access network, and a relay station that relays downlink communication and uplink communication between the radio access network and the communication device under the control of the radio access network, wherein
the communication control method comprises controlling an uplink transmission timing of the relay station to the radio access network in the relay of the uplink communication to be after the timing at which an uplink processing delay of the relay station in the relay is added to an uplink reception timing of the relay station from the communication device in the relay.

Item 10: A communication control method that controls by time division duplex a communication network comprising a radio access network, a communication device capable of communicating with the radio access network, and a relay station that relays downlink communication and uplink communication between the radio access network and the communication device under the control of the radio access network, wherein
the communication control method comprises controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

Item 11: A computer-readable medium storing a communication control program that controls by time division duplex a communication network comprising a radio access network, a communication device capable of communicating with the radio access network, and a relay station that relays downlink communication and uplink communication between the radio access network and the communication device under the control of the radio access network, wherein
the communication control program causes a computer to perform controlling an uplink transmission timing of the relay station to the radio access network in the relay of the uplink communication to be after the timing at which an uplink processing delay of the relay station in the relay is added to an uplink reception timing of the relay station from the communication device in the relay.

Item 12: A computer-readable medium storing a communication control program that controls by time division duplex a communication network comprising a radio access network, a communication device capable of communicating with the radio access network, and a relay station that relays downlink communication and uplink communication between the radio access network and the communication device under the control of the radio access network, wherein
the communication control program causes a computer to perform controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

The application claims priority of Japanese patent application 2022-155234, filed on Sep. 28, 2022, which is hereby incorporated by reference in its entirety.

### INDUSTRIAL APPLICABILITY

The present disclosure relates to timing control of relay station controlled by network.

### REFERENCE SIGNS LIST

1 wireless communication system, 2 communication device, 3 communication control apparatus, 11 5G wireless communication system, 12 4G wireless communication system, 13 satellite communication system, 31 timing controller, 32 communication controller, 111 5G base station, 112 5G cell, 121 4G base station, 122 4G cell, 131 communication satellite, 132 satellite communication cell, 133 gateway.

1. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a timing controller, controlling an uplink transmission timing of the relay station to the radio access network in the relay of the uplink communication to be after the timing at which an uplink processing delay of the relay station in the relay is added to an uplink reception timing of the relay station from the communication device in the relay.

2. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a timing controller, controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

3. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, delaying the uplink communication by the relay station to the radio access network until the further next uplink transmission timing in the time division duplex, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

4. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, causing the relay station to perform the uplink communication to the radio access network by using at least one flexible symbol allocated to an uplink symbol, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

5. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, increasing the number of uplink symbols allocated to an uplink reception timing and an uplink transmission timing of the relay station in the relay of the uplink communication, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

6. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, adjusting a downlink processing delay of the relay station in the relay of the downlink communication, if the timing at which an uplink processing delay of the relay station in the relay is added to an uplink reception timing of the relay station from the communication device in the relay of the uplink communication is after the timing at which a propagation delay between the relay station and the radio access network is subtracted from a next downlink reception timing in the time division duplex of the relay station from the radio access network in the relay of the downlink communication.

7. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a communication controller, imposing an upper limit on an uplink processing delay of the relay station in the relay of the uplink communication.

8. A communication control apparatus that controls by time division duplex a communication network comprising a radio access network, a communication device capable of communicating with the radio access network, and a relay station that relays downlink communication and uplink communication between the radio access network and the communication device under the control of the radio access network, wherein
the communication control apparatus comprises at least one processor that performs, by a processing delay sharing device, sharing from the relay station to the radio access network, at least one of a downlink processing delay of the relay station in the relay of the downlink communication and an uplink processing delay of the relay station in the relay of the uplink communication.

9. A communication control method that controls by time division duplex a communication network comprising a radio access network, a communication device capable of communicating with the radio access network, and a relay station that relays downlink communication and uplink communication between the radio access network and the communication device under the control of the radio access network, wherein
the communication control method comprises controlling an uplink transmission timing of the relay station to the radio access network in the relay of the uplink communication to be after the timing at which an uplink processing delay of the relay station in the relay is added to an uplink reception timing of the relay station from the communication device in the relay.

10. A communication control method that controls by time division duplex a communication network comprising a radio access network, a communication device capable of communicating with the radio access network, and a relay station that relays downlink communication and uplink communication between the radio access network and the communication device under the control of the radio access network, wherein
the communication control method comprises controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.

11. A computer-readable medium storing a communication control program that controls by time division duplex a communication network comprising a radio access network, a communication device capable of communicating with the radio access network, and a relay station that relays downlink communication and uplink communication between the radio access network and the communication device under the control of the radio access network, wherein
the communication control program causes a computer to perform controlling an uplink transmission timing of the relay station to the radio access network in the relay of the uplink communication to be after the timing at which an uplink processing delay of the relay station in the relay is added to an uplink reception timing of the relay station from the communication device in the relay.

12. A computer-readable medium storing a communication control program that controls by time division duplex a communication network comprising a radio access network, a communication device capable of communicating with the radio access network, and a relay station that relays downlink communication and uplink communication between the radio access network and the communication device under the control of the radio access network, wherein
the communication control program causes a computer to perform controlling an uplink transmission timing of the relay station to the radio access network in the relay of the uplink communication to be before the timing at which a propagation delay between the relay station and the radio access network is subtracted from a next downlink reception timing in the time division duplex of the relay station from the radio access network in the relay of the downlink communication.
